(19) United States
(12) Patent Application Publication
(10) Pub. No.: US 2008/0308658 A1
(43) Pub. Date: Dec. 18, 2008

(54) Fuel Injector

(76) Inventor: Anh-Tuan Hoang, Tamm (DE)

Correspondence Address: KENYON & KENYON LLP, ONE BROADWAY, NEW YORK, NY, 10004, US

(21) Appl. No.: 11/658,464

(22) PCT Filed: Jun. 3, 2005
(86) PCT No.: PCT/EP05/52553

§ 371 Date: Jan. 24, 2007

(30) Foreign Application Priority Data
Jul. 26, 2004 (DE) 10 2004 036 218.1
Sep. 2, 2004 (DE) 10 2004 042 592.2

(51) Int. Cl. F02M 61/16

(52) U.S. Cl. 239/585.1

(57) ABSTRACT

A fuel injector for fuel-injection systems of internal combustion engines includes a solenoid coil, an armature cooperating with the solenoid coil, a valve sleeve, and a support tube, situated in the valve sleeve, which is used as inner pole for the solenoid coil. The valve sleeve is made of a material having low magnetic permeability.

### FIELD OF THE INVENTION

The invention relates generally to a fuel injector for fuel-injection systems of internal combustion engines.

### DESCRIPTION OF RELATED ART

To stabilize or seal the actuator, for instance, fuel injectors include a valve sleeve, which is produced by deep drawing and essentially extends across the entire overall length of the fuel injector. Such a fuel injector is known from the printed publication DE 101 22,353, for example.

Due to the specifications with regard to their stability, the known fuel injectors have the particular disadvantage that the valve sleeve is made of a magnetizable material which produces a magnetic shunt during operation of the fuel injector, so that the maximally possible magnetic force is not available to actuate the fuel injector.

### SUMMARY OF THE INVENTION

In contrast, the fuel injector according to the present invention utilizes a valve sleeve which is made of a material having low magnetic permeability. The fuel injector (1) for fuel-injection systems of internal combustion engines includes a solenoid coil (2), an armature (9) cooperating with the solenoid coil (2), a valve sleeve (7), and a support tube (8) situated in the valve sleeve (7), which is used as inner pole for the solenoid coil (2), wherein the valve sleeve (7) is made of a material having low magnetic permeability. The fuel injector of the invention has the advantage that the valve sleeve is made of a material having low magnetic permeability, so that losses in the magnetic flux through the armature of the fuel injector are able to be avoided and the magnetic force is available in full.

Advantageous further refinements and improvements of the fuel injector are discussed in the Detailed Description below.

In an advantageous manner, the valve sleeve is made of a powder composite material that includes iron and non-magnetic admixtures.

Moreover, it is advantageous that a magnetic flux through the valve sleeve is reduced in favor of the magnetic flux through the armature and the inner pole of the magnetic circuit.

It is also advantageous that the valve sleeve is easy to produce by deep-drawing.

### BRIEF DESCRIPTION OF THE DRAWINGS

The present invention will be described in greater detail with reference to the following drawings wherein:

FIG. 1 shows a schematic section through an exemplary embodiment of a fuel injector.

FIG. 2 shows a schematic cut-away portion in region II of FIG. 1 of the fuel injector shown in FIG. 1.

FIG. 3 shows a schematic representation of the magnetic characteristic curve of the original material and of the material having modified magnetic characteristics.

### DETAILED DESCRIPTION OF THE INVENTION

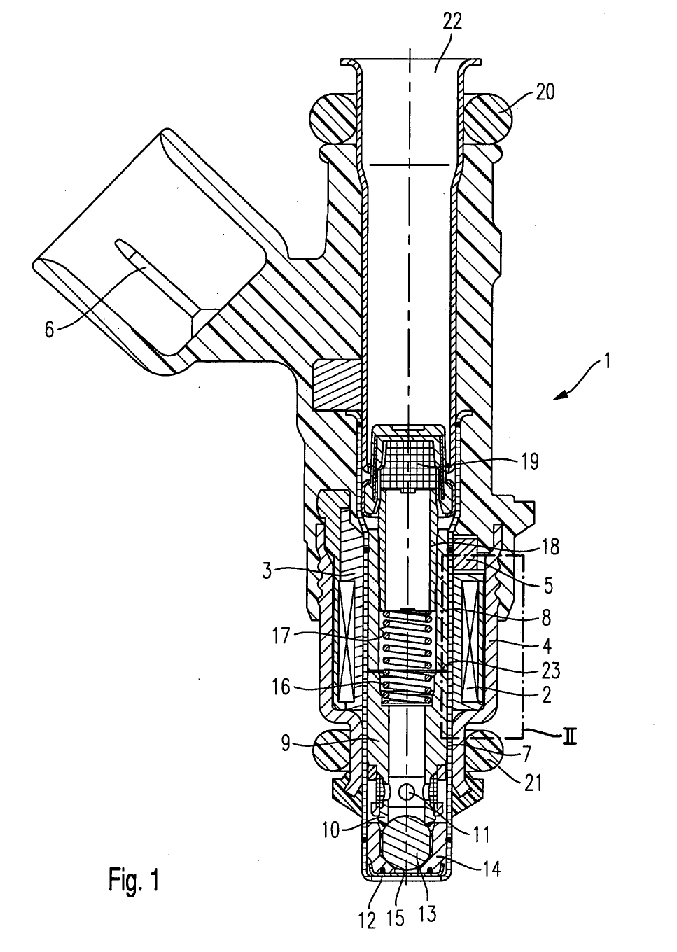

FIG. 1 first shows in a schematized sectional view a longitudinal section through a fuel injector 1, which is especially suited for the injection of fuel into an intake manifold (not shown further) of an internal combustion engine. Fuel injector 1 includes a solenoid coil 2, which is wound on a coil brace 3. Coil brace 3 is encapsulated in a valve housing 4, which serves as outer pole of solenoid coil 2 and is sealed by a top 5. A contact tag 6 is formed on coil brace 3.

Coil brace 3 is penetrated by a valve sleeve 7 having a tubular design. A support tube 8 is used as inner pole of solenoid coil 2 and simultaneously supports thin-walled valve sleeve 7. Downstream from support tube 8 is an armature 9, which, for instance, is integrally formed with a valve needle 10. Flow-through orifices 11 are provided in valve needle 10, which guide the fuel flowing through fuel injector 1 to a sealing seat.

Valve needle 10 is in operative connection with a valve-closure member 13, preferably by welding, the valve-closure member in the exemplary embodiment having a spherical shape and forming a sealing seat together with a valve-seat body 14. Downstream from the sealing seat at least one spray-discharge orifice 15 is formed in a spray-orifice plate 12, from which the fuel is injected into the intake manifold (not shown further).

In the rest state of fuel injector 1 a restoring spring 16 acts on armature 9 in such a way that fuel injector 1 is held closed on valve-seat body 14 by the contact pressure of valve-closure member 13. Restoring spring 16 is situated in a recess 17 of armature 9 or support tube 8 and prestressed by an adjusting sleeve 18.

A cup-shaped filter element 19 is preferably pressed into fuel injector 1 on the inflow side of adjusting sleeve 18. A seal 20 seals fuel injector 1 from a fuel distributor (not shown further), and another seal 21 seals it from the intake manifold (likewise not shown further). The fuel, conveyed via a central fuel supply 22, flows through fuel injector 1, through recess 17 and flow-through orifices 11, to the sealing seat and to spray-discharge orifice 15.

If an electric current is supplied to solenoid coil 2 via an electrical line (not shown further) and contact tag 6, a magnetic field will be generated that, if sufficiently strong, pulls armature 9 into solenoid coil 2, counter to the force of restoring spring 16 and counter to the flow direction of the fuel. This closes a working gap 23 formed between armature 9 and support tube 8. The movement of armature 9 also carries along in the lift direction valve needle 10, which is frictionally connected to armature 9, so that valve-closure member 13 lifts off from valve-seat body 14 and fuel is conveyed to spray-discharge orifice 15.

Fuel injector 1 is closed as soon as the electric current energizing solenoid coil 2 is switched off and the magnetic field has decayed to the point where restoring spring 16 presses armature 9 away from support tube 8, thereby moving valve needle 10 in the discharge direction and valve-closure member 13 coming to rest on valve-seat body 14.

As can be gathered from FIG. 1, fuel injector 1 has a valve sleeve 7, which is produced entirely by deep-drawing in order to lower the manufacturing cost by avoiding components that must be produced by cutting. Valve sleeve 7 ensures the stability of fuel injector 1 and at the same time seals solenoid coil 2 from the fuel.

Due to its wall thickness, which is determined by the system pressure and the manufacturability, valve sleeve 7 is magnetic in order to guide the magnetic flux between valve housing 4 and armature 9 and also between valve housing 4 and support tube 8 which acts as inner pole.

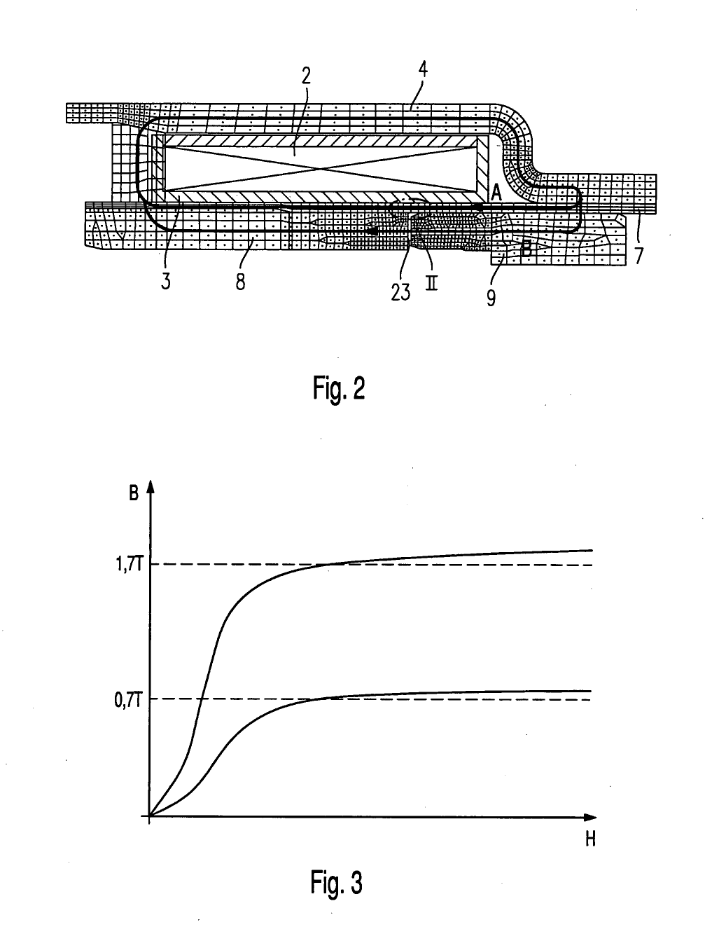

FIG. 2 shows the pattern of the magnetic flux in an enlarged view in the region about solenoid coil 2.

However, the path, denoted by A, of the magnetic flux across valve sleeve 7 constitutes a magnetic shunt in the region denoted by II since the magnetic flux follows the lower resistance in magnetic valve sleeve 7 at least partially and avoids working gap 23 in the process. This reduces the magnetic flux flowing along path B across working gap 23, so that the magnetic force maximally available for attracting armature 9 is reduced.

As a consequence, to compensate for this loss, the field strength of solenoid coil 2 or the voltage exciting solenoid coil 2 must be increased, which results in higher operating voltages, increased loading of the components and greater production expense.

In order to reduce or eliminate the partial flow according to characteristic A, it is common practice to interrupt the flow in valve sleeve 7 with the aid of a so-called magnetic separation. The overall flow then essentially flows across working gap 23 between armature 9 and support tube 8, which acts as inner pole. This requires either a mechanical connection of two magnetic and one non-magnetic partial sleeve, for instance by welding, or a thermal treatment of valve sleeve 7 in the region of solenoid coil 2, which is cost-intensive and may lead to reduced mechanical stability.

To avoid the aforementioned disadvantages, the present invention provides that the material from which valve sleeve 7 is produced be magnetically reduced overall, i.e., to reduce the saturation induction for entire valve sleeve 7 and not only for partial regions.

When examining FIG. 3 where magnetic flux H is plotted with respect to magnetic field strength B, it can be seen that a suitable selection of the material for valve sleeve 7 makes it possible to lower the saturation induction of valve sleeve 7 from originally approx. 1.7 Tesla by more than 50% or, in the example, by approx. 1 Tesla to approximately 0.7 Tesla. The saturation induction of valve sleeve 7 thus preferably amounts to less than 1 Tesla and, especially preferred, to less than 0.8 Tesla.

Suitable materials that allow such a reduction of the saturation induction are powder composite materials, for instance, in which non-magnetic powdery components or materials that inherently have reduced magnetic properties are added to the iron starting material.

Due to the lower permeability of the material of valve sleeve 7, the proportion of the shunt along path A in FIG. 2 is reduced, thereby allowing a performance increase compared to a valve sleeve 7 made of a material having higher permeability. The attractive force of solenoid coil 2 is able to be increased by 20% or more in this manner with the voltage remaining constant.

Materials having lower magnetic permeability usually also have reduced electric conductivity, so that, in addition to an increase in the static magnetic force, the dynamic response is able to be improved as well, thereby making it possible, for example, to improve the switch-off times by up to 40%.

The present invention is not limited to the exemplary embodiment shown and is suitable for any designs of fuel injectors 1, for instance for fuel injectors 1 for the direct injection of fuel or fuel injectors 1 connected to a common-rail system. In particular, any combination of the individual features is possible.

1-7. (canceled)

8. A fuel injector (1) for a fuel-injection system of an internal combustion engine, comprising a solenoid coil (2), an armature (9) cooperating with the solenoid coil (2), a valve sleeve (7), and a support tube (8) situated in the valve sleeve (7), which is used as inner pole for the solenoid coil (2), wherein the valve sleeve (7) is made of a material having low magnetic permeability.

9. The fuel injector according to claim 8, wherein the material is a powder composite material.

10. The fuel injector according to claim 9, wherein the powder composite material contains iron and non-magnetic components.

11. The fuel injector according to claim 8, wherein a magnetic flux through the valve sleeve (7) is much lower than a magnetic flux through the support tube (8) and the armature (9).

12. The fuel injector according to claim 9, wherein a magnetic flux through the valve sleeve (7) is much lower than a magnetic flux through the support tube (8) and the armature (9).

13. The fuel injector according to claim 10, wherein a magnetic flux through the valve sleeve (7) is much lower than a magnetic flux through the support tube (8) and the armature (9).

14. The fuel injector according to claim 8, wherein the valve sleeve (7) is able to be produced by deep-drawing.

15. The fuel injector according to claim 8, wherein the valve sleeve (7) is cup-shaped.

16. The fuel injector according to claim 9, wherein the valve sleeve (7) is cup-shaped.

17. The fuel injector according to claim 10, wherein the valve sleeve (7) is cup-shaped.

18. The fuel injector according to claim 11, wherein the valve sleeve (7) is cup-shaped.

19. The fuel injector according to claim 8, wherein the saturation induction of the valve sleeve (7) amounts to less than 1 Tesla.

20. The fuel injector according to claim 9, wherein the saturation induction of the valve sleeve (7) amounts to less than 1 Tesla.

21. The fuel injector according to claim 10, wherein the saturation induction of the valve sleeve (7) amounts to less than 1 Tesla.

22. The fuel injector according to claim 11, wherein the saturation induction of the valve sleeve (7) amounts to less than 1 Tesla.

23. The fuel injector according to claim 8, wherein the saturation induction of the valve sleeve (7) amounts to less than 0.8 Tesla.
